(19) United States
(12) Patent Application Publication
(10) Pub. No.: US 2008/0184960 A1
(43) Pub. Date: Aug. 7, 2008

(54) Throttle body with integrated reversion restriction

(76) Inventors: Steven M. Tassinari, Meridan, NH (US); Scott A. Tassinari, Norwich, VT (US)

Correspondence Address: DEVINE, MILLIMET & BRANCH, P.A., 111 AMHERST STREET, BOX 719, MANCHESTER, NH, 03105, US

(21) Appl. No.: 12/009,968

(22) Filed: Jan. 23, 2008

Related U.S. Application Data
(60) Provisional application No. 60/881,948, filed on Jan. 23, 2007.

(51) Int. Cl. F02D 9/08; F02D 9/18

(52) U.S. Cl. 123/403; 123/184.54

(57) ABSTRACT

The throttle body of the present invention includes a reversion restriction preferably in the form of a reed valve.

### CROSS-REFERENCE TO RELATED APPLICATIONS

The present application claims the benefit of provisional patent application Ser. No. 60/881,948 filed Jan. 23, 2007, which is incorporated herein by reference.

### TECHNICAL FIELD

The present invention relates to a throttle body with integrated reversion restriction. More specifically it relates to a throttle body with integrated reversion restriction for fuel-injected, 2-stroke and 4-stroke, internal combustion engines.

### BACKGROUND OF THE INVENTION

2-stroke and 4-stroke internal combustion engines (both, “engines”) can be tuned to produce high performance within certain revolutions per minute (“rpm”) ranges. Thus, certain camshaft profiles and timing are selected to provide optimum scavenging at high rpm. These selections result in valve overlap in the lower rpm range when both the intake and exhaust valves are open simultaneously. Excessive valve overlap or overly lengthy periods during which the intake valve is open both lead to the backflow of exhaust gas through the intake valves and down the intake tract (“reversion”) at low engine speeds, resulting in decreased combustion efficiency and lower engine output. Restricting this reversion yields significant performance increases at lower rpm for engines with valvetrains that are optimized for high rpm operation.

Many engine builders have utilized anti-reversion techniques in their engines. The prior art includes examples of reed valves in cylinder heads. FIG. 1 shows an example of such a 2-stroke motor reed valve. The reed valve 10 includes a v-shaped base 12, pliable reed petals 14, and stoppers 16. The base is substantially hollow with a plurality of openings covered by the reed petals 14. In operation, air flows into the center of the base 12 and through the openings in the base 12, pushing the reed petals 14 back towards the stoppers 16. When reversion occurs, the reed petals 14 press firmly against the base 12, covering the openings and substantially impeding the backflow of exhaust gas.

FIG. 2 shows another example of a traditional 2-stroke motor reed valve. The reed valve 20 includes a w-shaped base 22, pliable reed petals 24, guards 26, and an inner stopper 28. The design of this reed valve 20 creates a broader opening for passage of air and improved engine performance. Also the reed petals 24 against the guards 26 are not required to bend as far for the reed valve 20 to allow more airflow than the traditional reed valve 10 shown in FIG. 1 because of the volume of airflow allowed past the reed petals 24 against the inner stopper 28. The reduced movement radius of the reed petals 24 reduces wear on the reed petals 24. The reed petals 24 against the guards 26 are held between the guards 26 and the base 22 by screws 30. The reed petals 24 against the inside stopper 28 are held in place by the reed cage in the base 22 and the inside stopper 28.

However, placing such reed valves in cylinder heads requires expensive tooling and results in engines that are difficult to modify or repair. Thus, it is a purpose of the present invention to provide a means to restrict reversion in engines that is simple, that does not require expensive tooling, and that is easy to repair.

### SUMMARY OF THE INVENTION

The present invention integrates a reed valve assembly, or other means to restrict reversion, into the throttle body of a 2-stroke or 4-stroke engine instead of the cylinder heads, thereby decreasing tooling, manufacturing and replacement costs significantly.

### BRIEF DESCRIPTION OF THE DRAWINGS

These and other features and advantages of the present invention will be better understood by reading the following detailed description, taken together with the drawings wherein preferred embodiments are shown as follows:

FIG. 1 is a cross-sectional diagram of a reed valve in the prior art;

FIG. 2 is a cross-sectional diagram of another reed valve in the prior art;

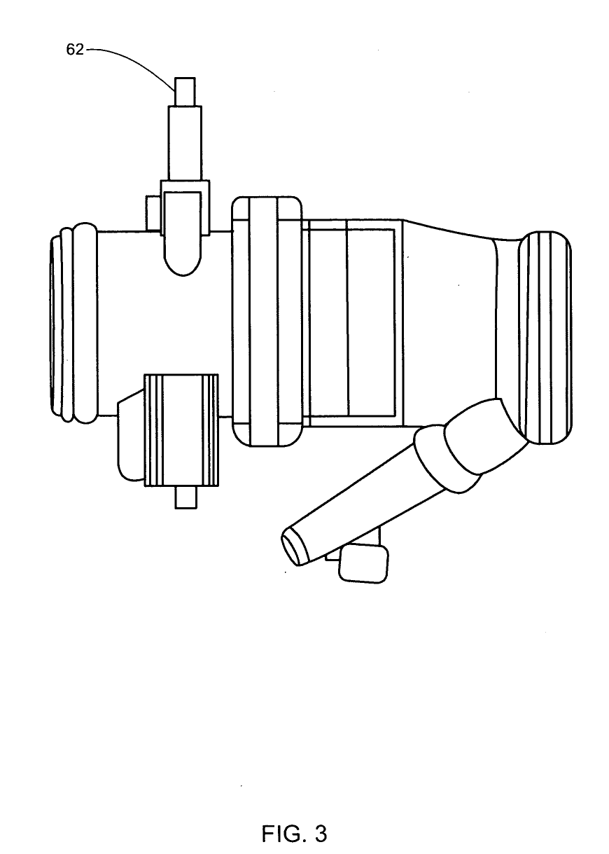

FIG. 3 is an exterior view of the throttle body of the present invention;

FIG. 4 is a view into a first end of the throttle body of FIG. 3;

FIG. 5 is a cutaway view of the throttle body of FIG. 3;

FIG. 6 is a cutaway view into a first end of the throttle body of FIG. 3;

FIG. 7 is a schematic diagram of the interior of the throttle body of FIG. 3; and

FIG. 8 is a schematic diagram of the interior of the throttle body of FIG. 3 during an intake cycle.

### DETAILED DESCRIPTION OF THE INVENTION

The present invention integrates a reed valve, or other means to restrict reversion known to those skilled in the art, into the throttle body of an engine instead of the cylinder head, thereby decreasing tooling and manufacturing costs significantly. Furthermore, installing and replacing a throttle body that bolts onto the main engine assembly are far simpler, and less expensive, tasks than replacing a cylinder head.

Current throttle bodies on engines provide means for the operator to alter the air flow (and, subsequently, engine output) into the engine's cylinders, usually through one or more butterfly valves. With the butterfly valve in its fully open position, the only obstruction in the intake tract between the air filter and an intake valve is the thin profile of the throttle plate itself.

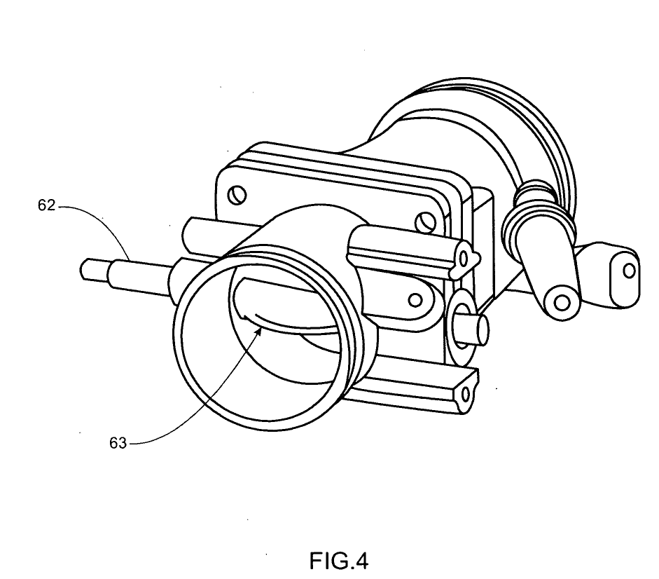

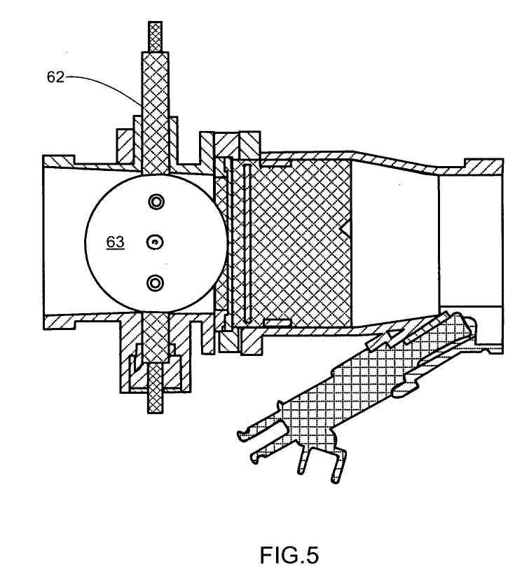

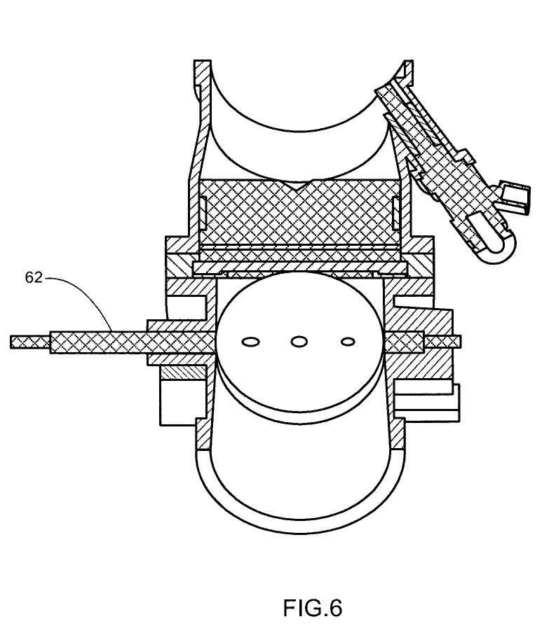

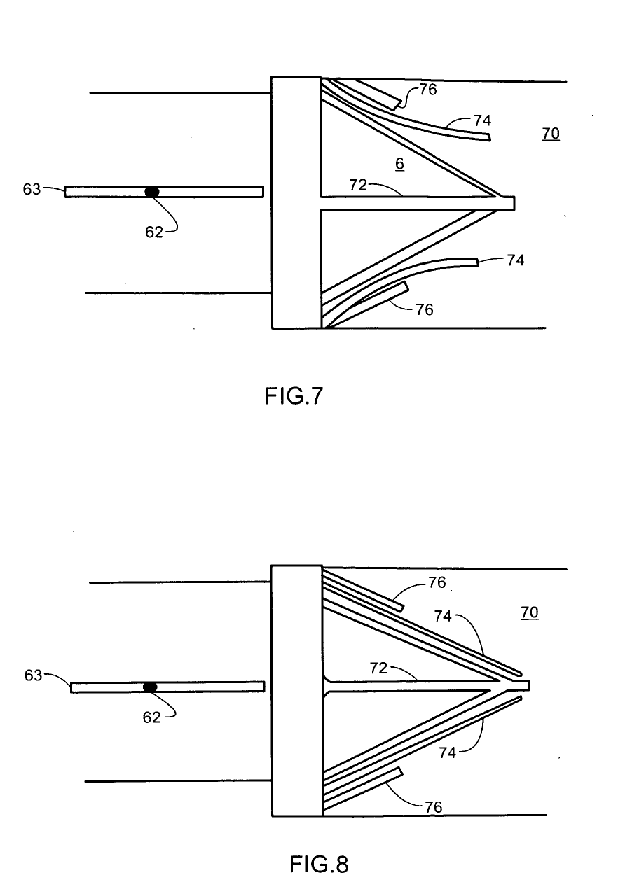

In a preferred embodiment of the present invention, as shown in FIGS. 3-8, a throttle body 60 has a butterfly valve 62 which is used to alter the airflow into the engines cylinders. The butterfly valve 62 is shown here in the fully open position, in which the thin profile of the throttle plate 63 provides little, if any, obstruction to the airflow.

The throttle body of a preferred embodiment of the present invention also employs an integrated means to restrict reversion. The throttle body still controls the flow of air into the cylinders, but the integrated reversion restriction also prevents backflow.

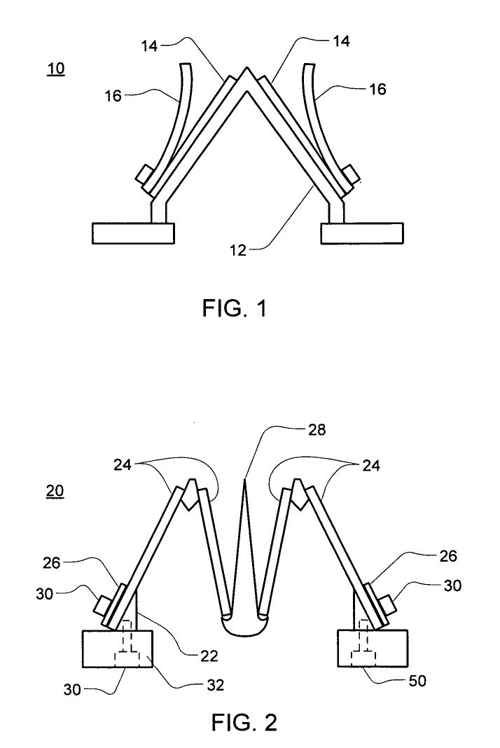

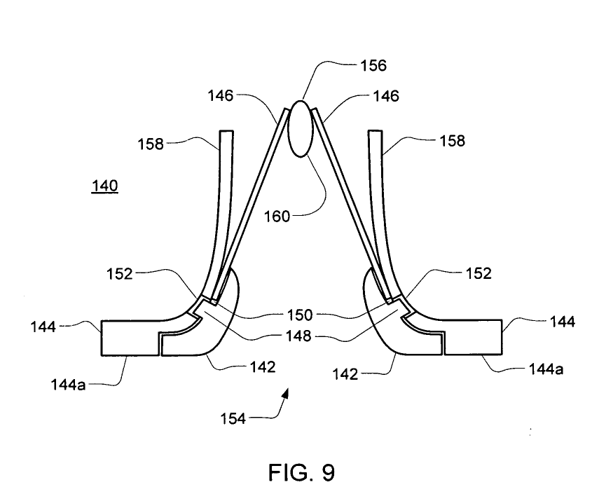

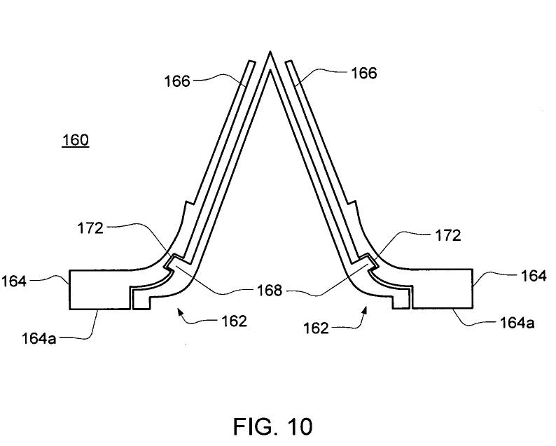

In one preferred embodiment of the present invention, as shown in FIGS. 7 and 8, the means to restrict reversion is a reed valve similar to that described in FIG. 1. The reed valve 70 includes a v-shaped base 72, pliable reed petals 74 and stoppers 76. The base is substantially hollow with a plurality of openings covered by the reed petals 74. In operation, as shown in FIG. 7, air flows in the center of the base 72 and through the openings in the base 72, pushing the reed petals 74 back toward the stoppers 76. When reversion occurs, as shown in FIG. 8, the reed petals 74 then close to prevent exhaust gases from flowing back through the throttle body. The petals 74 press firmly against the base 72, covering the openings and substantially impeding the backflow of exhaust gas. Reversion is reduced, increasing low rpm performance while maintaining the high rpm performance for which the valve train was designed.

Other preferred embodiments of the throttle body of the present invention incorporate other embodiments of reed valves. For example, one such embodiment, as shown in FIG. 9, includes a reed cage 142, a retainer 144, and reed petals 146. The retainer 144 is independently interlockable with the reed cage 142. Independently interlockable is understood to mean that no separate parts are required to connect the retainer 144 to the reed cage 142. As implied by the term interlockable, the retainer 144 and reed cage 142 are separable. The reed petals 146 are removably secured to the reed cage 142 by the retainer 144.

The reed petals 146 are secured to the reed cage 142 with the retainer 144. The retainer 144 is a flange 144a, one of several possible embodiments for the retainer 144. Tabs 148 are formed in the reed cage 142. The reed petals 146, with holes 150 formed therein, fit over the tabs 148 The flange 144a is slotted 152 to accept the tabs 148, thereby interlocking the retainer 144 to the reed cage 142 and securing the reed petals 146 in place.

Other embodiments of the throttle body of the present invention include the reed valve assemblies described in U.S. patent application Ser. No. 11/092,965 filed Mar. 29, 2005, which is incorporated herein by reference. For example, as shown in FIG. 10, reed valve assembly 160 includes a reed cage 162 and a retainer 164, with reed petals 166 that are an integral part of retainer 164. The retainer 164 is independently interlockable with reed cage 162. As defined herein, independently interlockable is understood to mean that no separate parts are required to connect the retainer 164 to the reed cage 162. As implied by the term interlockable, the retainer 164 and reed cage 162 are separable. The reed petals 166 are an integral part of the retainer 164. The retainer 164 is a flange 164a, one of several possible embodiments for the retainer 164. Tabs 168 are formed in the reed cage 162. The flange 164a is slotted 172 to accept the tabs 168, thereby interlocking the retainer 164 to the reed cage 162.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A throttle body assembly with a reversion restriction comprising a reed valve assembly.

2. The throttle body of claim 1 wherein the reed valve assembly further comprises
a reed cage, and
a retainer including in one piece a plurality of reed petals wherein the retainer is independently interlockable with the reed cage.

3. A throttle body assembly comprising a means to restrict reversion.
